(19) United States
(12) Patent Application Publication
(10) Pub. No.: US 2003/0029431 A1
(43) Pub. Date: Feb. 13, 2003

(54) Tile cutter

(75) Inventor: Paul S. Hepworth, Guildford (GB)

Correspondence Address: NIKOLAI & MERSEREAU, P.A., 900 SECOND AVENUE SOUTH, SUITE 820, MINNEAPOLIS, MN, 55402, US

(73) Assignee: Turner Intellectual Property Limited, Burton-on-Trent (GB)

(21) Appl. No.: 10/214,856

(22) Filed: Aug. 8, 2002

(30) Foreign Application Priority Data
Aug. 11, 2001 (GB) 0119681.5

(51) Int. Cl. B28D 1/04

(52) U.S. Cl. 125/13.03; 125/13.01

(57) ABSTRACT

A tile cutter comprising a base having a support surface upon which tiles to be cut may be supported, a pair of guide rails mounted upon the base, the guide rails being parallel to one another and being spaced from said support surface to enable a tile to be located between the guide rails and said support surface, a cutter assembly mounted on a carriage, the carriage being moveably mounted on said pair of rails so as to guide said cutter assembly along a rectilinear path across said support surface, the base having a first end and a second, opposite end, the tile being cut at or in the viscinity of the first end, the rails being mounted on the base by first and second bosses positioned at the first and second ends respectively of the base, characterized in that the base and the bosses are formed integrally with one another.

The present invention relates to a tile cutter, and particularly but not exclusively to a tile cutter for cutting ceramic tiles of the type for covering walls or floors.

A known tile cutter comprises a base having support surface upon which tiles to be cut may be supported, a pair of guide rails mounted upon the base, the guide rails being parallel to one another and being spaced from said support surface to enable a tile to be located between the guide rails and said support surface, a cutter assembly mounted on a carriage, the carriage being moveably mounted on said pair of rails so as to guide said cutter assembly along a rectilinear path across said support surface, the base having a first end at and towards which a tile may be cut, and a second, opposite end.

The tile to be cut is positioned towards the first end of the base and located by the tile stop.

The base further comprises an upstanding ridge extending along the length of the base and parallel to the longitudinal axis of the base.

A tile is placed at the first end abutting the tile stop and on the ridge. A cut is then effected in the tile by placing the cutter assembly onto the tile and exerting pressure on the tile by the cutter assembly whilst moving the cutter assembly along the tile. The pressure exerted on the tile causes a cut to be formed along a line corresponding to the position of the ridge relative to the tile.

Because pressure is applied to the tile towards the first end of the base of the tile cutter, it is necessary for the base to have sufficient strength to withstand these pressures.

It is known therefore to make the base from a sheet metal. The tile stop is attached to the base by means of screws extending through the tile stop and the base. The base is therefore generally formed with thread apertures to receive the screws.

The bosses are usually formed separately from the base, and the base may further comprise strengthening means such as ribbing.

According to a first aspect of the present invention there is provided a tile cutter comprising a base having a support surface upon which tiles to be cut may be supported, a pair of guide rails mounted upon the base, the guide rails being parallel to one another and being spaced from said support surface to enable a tile to be located between the guide rails and said support surface, a cutter assembly mounted on a carriage, the carriage being moveably mounted on said pair of rails so as to guide said cutter assembly along a rectilinear path across said support surface, the base having a first end and a second, opposite end, the tile being cut at or in the viscidity of the first end, the rails being mounted on the base by first and second bosses positioned at the first and second ends respectively of the base, characterised in that the base and the bosses are formed integrally with one another.

By forming the bosses integrally with the base, the manufacturing process is greatly simplified and it is not necessary to have a separate process to attach the bosses to the base.

Preferably the base and the bosses are made from a sheet metal.

According to the second aspect of the present invention there is provided a tile cutter comprising a base having a support surface upon which tiles to be cut may be supported, a pair of guide rails mounted upon the base, the guide rails being parallel to one another and being spaced from said support surface to enable a tile to be located between the guide rails and said support surface, a cutter assembly mounted on a carriage, the carriage being moveably mounted on said pair of rails so as to guide said cutter assembly along a rectilinear path across said support surface, the base having a first end and a second, opposite end, the tile being cut at and in the vicinity of the first end of the base, characterised in that the base further comprises a lower support portion attached to an underside of the base at the first end of the base and a tile stop attached to a top surface of the base at the first end of the base, the lower support portion and the tile stop being formed from a plastics material and attached to the base so as to sandwich the base between the lower support portion and the tile stop.

Because both the lower support portion and the tile stop are formed from a plastics material, it is possible to injection mould each of these components such that they may be accurately shaped.

Preferably the lower support portion and the tile stop are attached to the base portion by means of screws or nails extending through the tile stop, the base and into the lower support portion.

Preferably the tile stop, base and lower support portion are attached to one another by means of one or more countersunk screws which extend through corresponding apertures formed in each of the lower support portion, base and tile stop.

Because the support portion and tile stop are formed from a plastics material, it is possible to use a self-tapping screw which forms threads within the apertures as the screw is screwed into the tile stop initially and then the lower support portion.

When the one or more screws have been tightened, the base is held securely between the tile stop and the lower support portion.

The base portion is formed with apertures which correspond in position to the apertures in the lower support portion and the tile stop, for receiving the one or more screws. However it is not necessary for these apertures in the base to be threaded since the one or more screws are held in place by the threads formed in the tile stop and/or the lower support portion as the one or more screws are screwed into these components.

The process of manufacturing the base from a sheet metal is therefore further simplified in that it is not necessary to form threaded apertures in the base in order to secure the base to the lower support portion and the tile stop.

The invention will now be further described by way of example only with reference to the accompanying drawings in which:

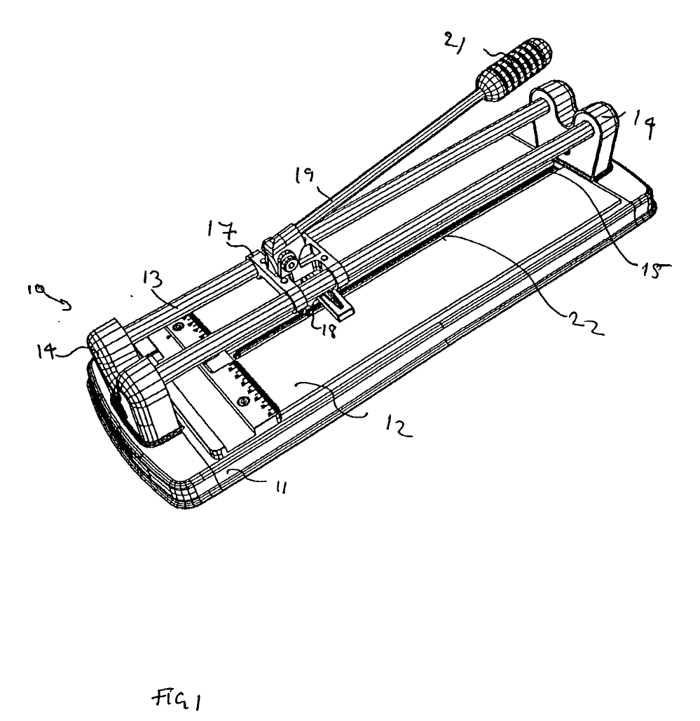

FIG. 1 is a schematic representation of a tile cutter according to the present invention;

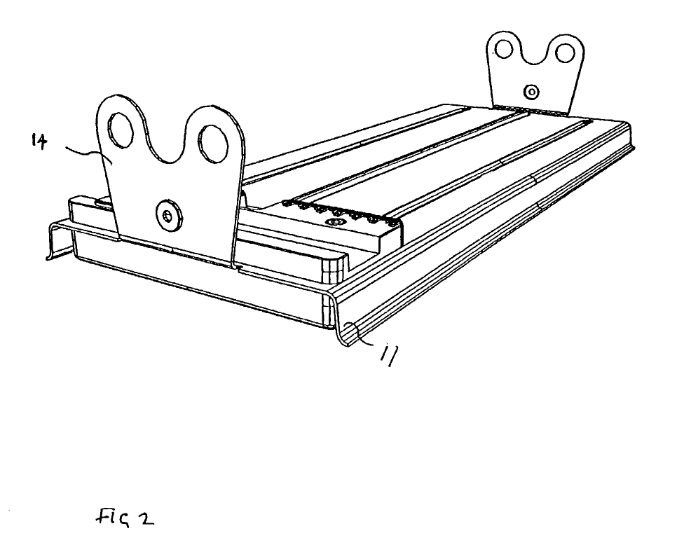

FIG. 2 is a schematic representation of part of the tile cutter of FIG. 1 showing how the bosses are integrally formed with the base;

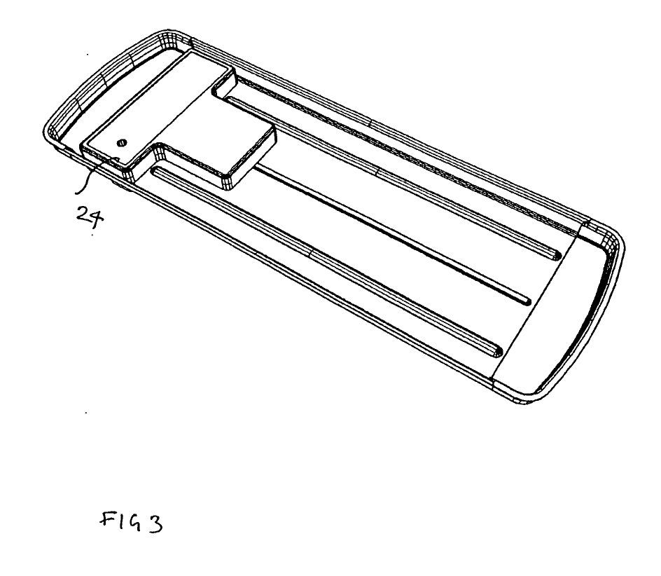

FIG. 3 is a schematic representation of the underside of the base showing the lower support portion;

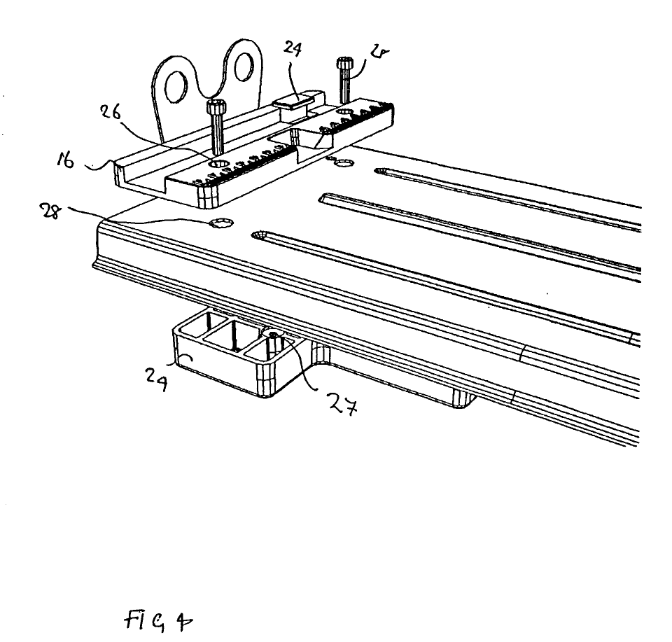

FIG. 4 is an exploded view of part of the tile cutter of FIG. 1 showing how the tile stop, base and lower support portion may be attached to one another;

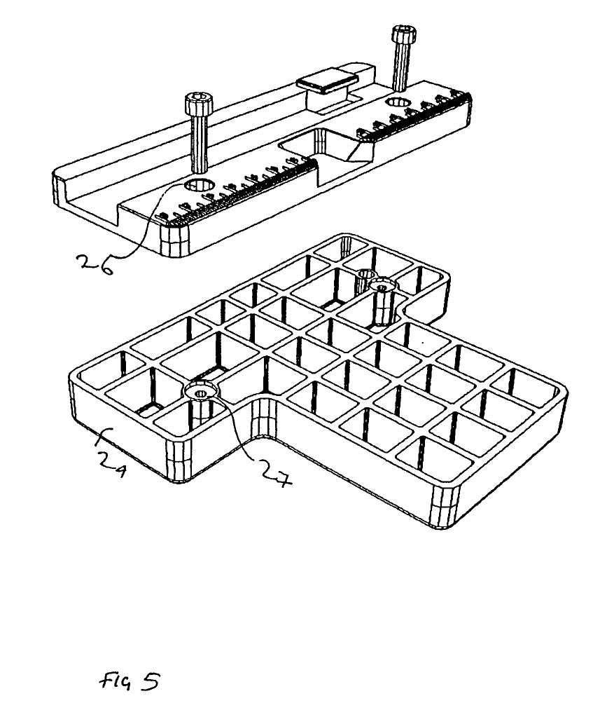

FIG. 5 is a schematic representation showing the apertures formed within the tile stop and lower support portion;

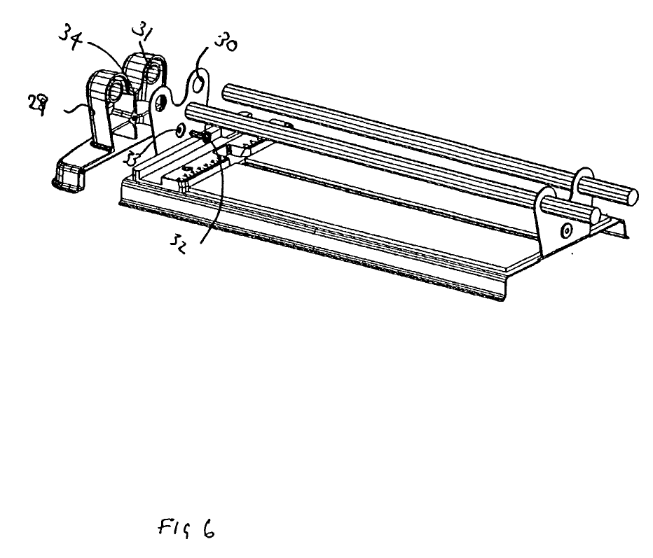

FIG. 6 is a schematic representation showing how the tile cutter of FIG. 1 may be assembled.

Referring to the Figures, a tile cutter according to an embodiment of the present invention is designated generally by the reference numeral 10. Tile cutter 10 comprises a base 11 which has an upper planar support surface 12 upon which tiles to be cut are placed.

A pair of guide rails 13 are mounted on the base 11 by a pair of bosses 14 into which opposed ends of the rails 13 are received. The rails 13 are mounted so as to be parallel to one another and also parallel with the planar support surface 21. The base further comprises a ridge 15 extending along the length of the base 11, a tile stop 16 positioned at one end of the tile cutter and a cutter assembly 17 mounted on the rails 13. The cutter assembly comprises a cutter wheel 18 rotatably mounted on one end of a lever 19 which is pivotally mounted on a carriage body 20 on which the cutter assembly 17 is mounted. The lever 19 is mounted on the carriage body 20 via a pivotal connection. The opposite end of the lever 19 extends longitudinally of the rails 13 to define a handle 21.

Preferably the pivotal connection is located centrally of the carriage body 20 so as to position the cutter assembly 18 centrally between the rails 13.

The cutter wheel 18 has an axis of rotation perpendicular to the axis of the rails 13 so that movement of the carriage body 20 along the rails 13 causes the cutter wheel 18 to move along a rectilinear path in which the wheel 18 is maintained perpendicular to the base 11.

The wheel 18 is opposed to the ridge 15 during its travel along the rails 13. In use, a tile is placed upon the base 11 so that it abuts against the tile stop 16. In this position it is supported on the ridge 15 and downward pressure applied by the cutter wheel 18 scores the tile as the cutter assembly 17 travels along the rails 13. This downward pressure is opposed by the ridge 15.

Preferably the ridge 15 comprises a channel 22 formed in the base 11 and a rod 23 of a rigid wear resistant material mounted within the channel 22.

After scoring of the tile the rod 23 acts as a breaker bar for snapping the tile along a score line created by the cutter.

The support surface 12 comprises two portions positioned on either side of the ridge 15. The thickness of the support surface is approximately the same as the height of the ridge 15, and thus prevents a tile from rocking when placed on the base 11. The support surface is preferably made of a deformable material such as foam rubber. When downward pressure is applied to the tile, the support surface deforms, thus allowing the tile to be broken along the score line.

To enable snapping of the tile to be achieved, the lever 19 is preferably provided with a pressure-foot (not shown) located on the opposite side of the lever's pivotal connection such that downward movement of the lever enables the foot to be brought into contact with the tile and for downward pressure to be applied thereto through the foot. The tile stop 16 comprises a tile locating portion 24 for locating the tile appropriately relative to the ridge 15 to ensure that a cut is effected in the appropriate place.

The guide rails 13 are mounted on the base by means of the bosses 14 which are integrally formed with the base 11.

The base is preferably made from a sheet metal in order to provide strength to the tile cutter 10. The bosses 14 may be punched out to the required shape during the sheet metal process. By forming the bosses 14 integrally with the base 11, it is not necessary to use welding processes for example to attach the bosses to the base 11. Each of the bosses further comprises an outer portion 29 formed from a plastics material. The outer portion may be injection moulded to an appropriate shape.

Each boss comprises guide rail receiving apertures 30, and the outer portion 29 of each boss comprises corresponding guide rail receiving apertures 31. In addition, the outer portion 29 is attached to the boss 14 by means of a screw 32 receivable within apertures 33 and 34 formed in the boss 40 and outer portion 29 respectively.

Because the apertures 28 in base 11 do not need to be threaded, the process of forming the apertures in the base 11 is greatly simplified. The apertures may be punched out of the sheet metal during formation of the base 11 and the bosses 14.

In order to provide further strength to the tile cutter 10 in the region where the downward pressure will be applied to the tile, the tile cutter 10 further comprises a lower support portion 24 attached to an underside of the base in a corresponding position to the tile stop 16 which is attached to an upper surface of the base 11.

Preferably both the tile stop 16 and the lower support portion 24 are formed from a plastics material. This enables both of the tile stop and the lower support portion to be formed from an injection moulding process. This means that each of these components 11, 24 may be accurately dimensioned.

The tile stop 16 and the lower support portion 24 are attached to the base 11 such that the base is sandwiched between tile stop 16 and the lower support portion 24.

Preferably the tile stop 16 and the lower support portion 24 are attached to the base 11 by means of screws 25 or other fixing means.

Because the tile stop 16 and the lower support portion 24 are formed from an injection moulding process, the apertures 26 for receiving the screws 25 may be accurately formed and positioned within each of the components 11, 24. The apertures 26 formed in the tile stop may be simple unthreaded apertures whilst the apertures 27 in the lower support portion 24 are self-tapping bores.

The base 11 is also formed with corresponding apertures 28 which need not be threaded. During assembly of the tile cutter 10, the tile stop 16 and the lower support portion 24 are moved into position so that the apertures 26, 27 and 28 are aligned with one another. A screw 25 is then inserted into a respective aperture and screwed into the countersunk apertures 27 in the lower support portion. Threads are thus formed in the apertures 27 during the process of screwing the screws 25 into the apertures 27. The three components 16, 11 and 24 are then held securely in place.

1. A tile cutter comprising a base having a support surface upon which tiles to be cut may be supported, a pair of guide rails mounted upon the base, the guide rails being parallel to one another and being spaced from said support surface to enable a tile to be located between the guide rails and said support surface, a cutter assembly mounted on a carriage, the carriage being moveably mounted on said pair of rails so as to guide said cutter assembly along a rectilinear path across said support surface, the base having a first end and a second, opposite end, the tile being cut at or in the viscinity of the first end, the rails being mounted on the base by first and second bosses positioned at the first and second ends respectively of the base, characterised in that the base and the bosses are formed integrally with one another.

2. A tile cutter according to claim 1 wherein the base and the bosses are made from a sheet metal.

3. A tile cutter comprising a base having a support surface upon which tiles to be cut may be supported, a pair of guide rails mounted upon the base, the guide rails being parallel to one another and being spaced from said support surface to enable a tile to be located between the guide rails and said support surface, a cutter assembly mounted on a carriage, the carriage being moveably mounted on said pair of rails so as to guide said cutter assembly along a rectilinear path across said support surface, the base having a first end and a second, opposite end, the tile being cut at or in the viscinity of the first end of the base, characterised in that the base further comprises a lower support portion attached to an underside of the base at the first end of the base and a tile stop attached to a top surface of the base at the first end of the base, the lower support portion and the tile stop being formed from a plastics material and being attached to the base to sandwich the base between the lower support portion and the tile stop.

4. A tile cutter according to claim 1 or claim 2 further comprising a lower support portion attached to an underside of the base at a first end of the base, and a tile stop attached to a top surface of the base at the first end of the base, the lower support portion and the tile stop being formed from a plastics material.

5. A tile cutter according to claim 3 or claim 4 wherein each of the lower support portion and the tile stop are formed with at least one screw receiving portion and the base is formed with an aperture positioned correspondingly to the at least one screw receiving portion in the lower support portion and tile stop.
